(19) United States
(12) Patent Application Publication
(10) Pub. No.: US 2010/0305748 A1
(43) Pub. Date: Dec. 2, 2010

(54) COMMODITY SELECTION SYSTEMS AND METHODS

(76) Inventors: Hsin Wen YOU, Yilan City (TW); Feng-Cheng LIN, Taipei City (TW); Chih-Hao HSU, Taipei City (TW); Han-Chao LEE, Taipei City (TW)

Correspondence Address: BIRCH STEWART KOLASCH & BIRCH, PO BOX 747, FALLS CHURCH, VA, 22040-0747, US

(21) Appl. No.: 12/560,952

(22) Filed: Sep. 16, 2009

(30) Foreign Application Priority Data
May 27, 2009 (TW) 98117697

(51) Int. Cl. G06F 7/00

(52) U.S. Cl. 700/216

(57) ABSTRACT

Commodity selection systems and methods are provided. The system includes a storage unit and a processing unit. The storage unit stores sales data corresponding to a plurality of sales commodities, and at least one attribute for each of a plurality of commodities, wherein the commodities include the sales commodities of the commodity sales machine, and a plurality of candidate commodities. The processing unit determines indication data for the respective sales commodity according to the sales data of the respective sales commodities, and uses a classification algorithm to set up a machine sales model according to the attributes and the indication data corresponding to the sales commodities. The processing unit applies each of the candidate commodities to the machine sales model, thus to obtain the indication data for the corresponding candidate commodity. The processing unit selects at least one of the candidate commodities with first specific indication data to replace at least one of the sales commodities with second specific indication data.

### CROSS REFERENCE TO RELATED APPLICATIONS

This Application claims priority of Taiwan Patent Application No. 098117697, filed on May 27, 2009, the entirety of which is incorporated by reference herein.

### BACKGROUND OF THE INVENTION

1. Field of the Invention

The disclosure relates generally to commodity selection systems and methods, and more particularly, to systems and methods that dynamically adjust sales commodities according to sales data for a commodity sales machine.

2. Description of the Related Art

Some commodity organizations, such as drink or cigarette companies can sale commodities using a commodity sales machine, such as a vending machine, a commodity showcase/an open commodity shelf for self-help shopping, and an unmanned store. Particularly, the vending machine can accomplish the sales of commodities without manual labor, thus saving manpower. Additionally, the vending machine can be set up at various locations, thus providing convenience for users to purchase commodities.

Generally, the selection of commodities for a commodity sales machine include a selection of commodities to be first sold in the commodity sales machine, and a selection of commodities to be replaced after the commodities have been sold in the commodity sales machine. Currently, the selection of commodities to be first sold and the selection of commodities to be replaced after the commodities have been sold are manually determined. For example, the commodities having a better sales status (or called higher sales turnover) on other commodity sales machines can be selected as the commodities to be first sold on a commodity sales machine. After the commodity sales machine begins to sell the commodities, the commodities having a worse sales status (or called low sales turnover) on the commodity sales machine are taken off the shelf, and the commodities having a better sales status on other commodity sales machines can be used to replace the off-shelf commodities.

U.S. Patent Application No. 20050043011 discloses a system and method to adjust commodities of a vending machine. In this prior art, the sales statuses of machines in various locations can be used to assist the commodity selection for a specific machine. However, if no sales status data of other machines is available, the commodity selection cannot be completed. Additionally, since the commodities are selected according to the commodities having a better sales status on other machines which may be set at various regions, and the different regions may have different specific requirements, the commodities determined according to the sales statuses from other regions may be unsuitable for the machine in a specific region.

### BRIEF SUMMARY OF THE INVENTION

Commodity selection systems and methods are provided.

An embodiment of a commodity selection system includes a storage unit and a processing unit. The storage unit stores sales data corresponding to a plurality of sales commodities of a commodity sales machine, and at least one attribute for each of a plurality of commodities, wherein the commodities include the sales commodities of the commodity sales machine and a plurality of candidate commodities. The processing unit determines indication data of the respective sales commodity according to the sales data of the respective sales commodities, wherein the indication data is one of a plurality of specific indication data. A classification algorithm is used by the processing unit to set up a machine sales model according to the attributes and the indication data corresponding to the sales commodities, and applies each of the candidate commodities to the machine sales model, thus to obtain the indication data for the corresponding candidate commodity. The processing unit selects at least one of the candidate commodities with first specific indication data to replace at least one of the sales commodities with second specific indication data.

In an embodiment of a commodity selection method, sales data corresponding to a plurality of sales commodities of a commodity sales machine, and at least one attribute for each of a plurality of commodities are recorded, wherein the commodities include the sales commodities of the commodity sales machine and a plurality of candidate commodities. Indication data for the respective sales commodity is determined according to the sales data of the respective sales commodities, wherein the indication data is one of a plurality of specific indication data. A machine sales model is set up according to the attributes and the indication data corresponding to the sales commodities using a classification algorithm, and each of the candidate commodities is applied to the machine sales model, thus to obtain the indication data for the corresponding candidate commodity. Then, at least one of the candidate commodities with first specific indication data is selected to replace at least one of the sales commodities with second specific indication data.

In some embodiments, the processing unit further uses a clustering algorithm to cluster the sales commodities according to the sales data of the respective sales commodities, thus to obtain a plurality of clusters, wherein the sales commodities in each cluster have the same indication data. In some embodiments, the processing unit selects at least one of the candidate commodities with the first specific indication data to replace the sales commodities in a specific cluster, wherein each of the sales commodities in the specific cluster have the second specific indication data.

In some embodiments, when each of the candidate commodities is applied to the machine sales model, and at least one of the candidate commodities without indication data is existed, the processing unit further determines a specific number of candidate commodities without indication data to replace a portion of the sales commodities in the specific cluster according to the number of the sales commodities in the specific cluster, the number of the candidate commodities with the first specific indication data, and the number of the candidate commodities without indication data.

In some embodiments, the processing unit further calculates a conditional probability for the respective candidate commodity according to the machine sales model, wherein the conditional probability is a probability that the indication data of the respective candidate commodity becomes the first specific indication data under the attribute of the candidate commodity. In some embodiments, the processing unit further determines a sequence of the candidate commodities, wherein the sequence of the candidate commodities is selected to replace the sales commodities with the second specific indication data according to the conditional probabilities of the respective candidate commodities.

In some embodiments, a meta-heuristic algorithm is further used by the processing unit to determine the sales commodities according to the attributes of a plurality of commodities, wherein the coverage of the attributes corresponding to the determined sales commodities is maximum. It is understood that, each attribute may correspond to one of a plurality of different contents, and the coverage of the attributes means the number of the corresponded contents. A plurality of combinations of the commodities can be determined, and a specific combination of the sales commodities can be determined as the sales commodities among the determined combinations, wherein the coverage of the attributes corresponding to the specific combination of the commodities is maximum among other combinations of the commodities.

Commodity selection systems and methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a commodity sales machine and a commodity selection system of the invention;

FIG. 2 is a schematic diagram illustrating an embodiment of a system architecture of a commodity selection system of the invention;

FIG. 3 is a schematic diagram illustrating an embodiment of an example of a machine sales model of the invention;

FIG. 4 is a schematic diagram illustrating an embodiment of a processing unit of the invention;

FIG. 5 is a flowchart of an embodiment of a commodity selection method of the invention;

FIG. 6 is a flowchart of an embodiment of a method for planning storage areas of the invention;

FIG. 7 is a flowchart of an embodiment of a method for selecting commodities to be sold for the first time in a commodity sales machine of the invention;

FIG. 8 is a flowchart of an embodiment of a method for a commodity replacement of the invention;

FIG. 9 is a table showing an example of 14 candidate commodities with a size smaller than the size of a class of storage areas; and

FIG. 10 is a table showing two combinations for selected commodities.

### DETAILED DESCRIPTION OF THE INVENTION

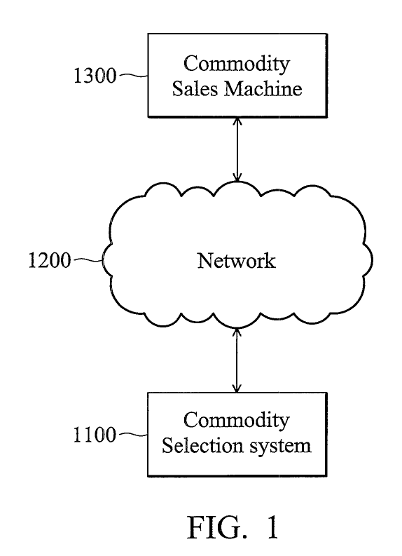

FIG. 1 is a schematic diagram illustrating an embodiment of a commodity sales machine and a commodity selection system of the invention. As shown in FIG. 1, the commodity selection system 1100 can be connected to at least one commodity sales machine 1300 via a network 1200. The commodity sales machine 1300 may be a vending machine, a commodity showcase/an open commodity shelf for self-help shopping, an unmanned store, and others. The commodity sales machine 1300 may have a predefined number of slots or storage shelves. Each of the slots or storage shelves may have the same or different sizes, such as in width and height. Various commodities can be placed in the slots or storage areas for sale. In some embodiments, the commodity sales machine 1300 can automatically record sales data of the sales commodities thereon. In some embodiments, the sales data is not recorded by the commodity sales machine 1300, but recorded by a payment device (not shown in FIG. 1) after the sales commodities are sold. The sales data can be transmitted to the commodity selection system 1100 via the network 1200.

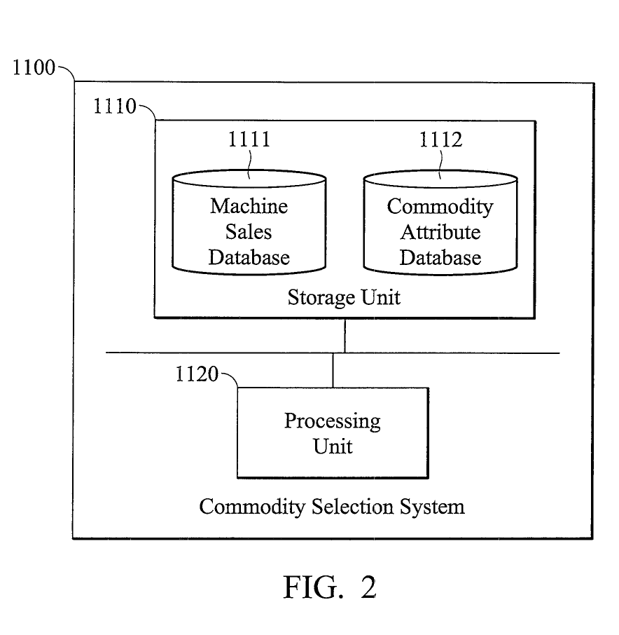

FIG. 2 is a schematic diagram illustrating an embodiment of a commodity selection system of the invention. The commodity selection system 1100 at least comprises a storage unit 1110 and a processing unit 1120. In some embodiments, the storage unit 1110 can further comprise a machine sales database 1111 and a commodity attribute database 1112. The commodity selection system 1100 can be used in an electronic device, such as a computer system, a handheld computer, a notebook, a server, a PDA, a workstation, or any calculator that can perform calculations and data processing.

The storage unit 1110 can store sales data corresponding to a plurality of sales commodities of a commodity sales machine, and at least one attribute for each of a plurality of commodities are recorded, wherein the commodities include the sales commodities of the commodity sales machine and a plurality of candidate commodities. In this embodiment, the machine sales database 1111 can record sales data for a plurality of commodities on at least one commodity sales machine. In some embodiments, the sales data can comprise any one, or a combination of at least any two of a name, a serial number, a sales quantity, and a profit corresponding to a commodity. It is understood that, in some embodiments, the sales data can be transmitted from the commodity sales machine 1300 to the commodity selection system 1100 via the network 1200. In some embodiments, the sales data can be first accessed from the machine, and then stored to the commodity selection system 1100 using a storage medium. In some embodiments, the sales data can be input to the commodity selection system 1100 via an operational interface provided by the system 1100.

In this embodiment, the commodity attribute database 1112 can record at least one attribute for the respective commodities. The commodities may be the sales commodities currently being sold in the commodity sales machine 1300, or candidate commodities which are not currently being sold in the commodity sales machine 1300. The attribute can comprise any one, or a combination of at least any two of a brand, a supplier, a type, a volume, and a price corresponding to a commodity. It is understood that, each attribute may correspond to one of a plurality of different contents. For example, attribute “brand” may be brand “A”, “B”, or “C”.

The main function of the processing unit 1120 is to determine and provide indication data to the respective sales commodity according to the sales data of the respective sales commodities, wherein the indication data is one of a plurality of specific indication data. The specific indication data can be variously implemented, and the name and number (representation) of the specific indication data can be varied according to various applications and requirements. For example, the specific indication data may be classified into three levels, named “Bad”, “Middle”, and “Good”. For example, the specific indication data may be classified into five levels, named “1”, “2”, “3”, “4”, and “5”. It is noted that, the specific indication data is an example of the application, and the present invention is not limited thereto.

The processing unit 1120 can provide indication data of the respective sales commodity in various manners. In some embodiments, a clustering algorithm, such as a k-means clustering method, a k-medoids clustering method, a hierarchical clustering method, a density-based clustering method, a grid-based clustering method, and a model-based clustering method, can be used to determine the indication data of the respective sales commodity. For example, it is assumed that the k-means clustering method is used, sales commodities P1˜P15 are provided, and three specific indication data of “Bad”, “Middle”, and “Good” is provided. The processing unit 1120 can cluster the sales commodities into three clusters according to the sales data of the sales commodities. These three clusters can respectively represent that the sales status of the respective sales commodity in the respective clusters is good, middle, or worst, and the sales commodities in the respective clusters may have the specific indication data of “Good”, “Middle”, and “Bad”, as shown in

TABLE 1

| | Product Serial | Sales | Indication |
|---|---|---|---|
| Product Name | Number | Data | Data |
| Product A(480 ml) | P1 | 46 | Good |
| Product B(350 ml) | P2 | 56 | Good |
| Product C(400 ml) | P3 | 22 | Middle |
| Product D(355 ml) | P4 | 52 | Good |
| Product E(450 ml) | P5 | 60 | Good |
| Product F(340 ml) | P6 | 26 | Middle |
| Product G(350 ml) | P7 | 66 | Good |
| Product H(240 ml) | P8 | 32 | Middle |
| Product I(240 ml) | P9 | 32 | Middle |
| Product J(240 ml) | P10 | 34 | Middle |
| Product K(338 ml) | P11 | 8 | Bad |
| Product L(227 ml) | P12 | 6 | Bad |
| Product M(227 ml) | P13 | 8 | Bad |
| Product N(200 ml) | P14 | 6 | Bad |
| Product O(200 ml) | P15 | 10 | Bad |

Further, the processing unit 1120 can first calculate the sales data using a specific formula, and provide data obtained from the calculation to the clustering algorithm for clustering. The specific formula can be a formula for calculating a sales profit, a sales achievement, a sales effect, a sales amount, or a market share for a commodity, based on the sales data.

In some embodiments, various sales criteria can be set in advance. The respective sales criteria may be set by considering various factors. In some embodiments, the sales criteria may be a total sales volume, a total sales quantity, a total sales profit, a market share, or any one or any combination thereof. The processing unit 1120 can evaluate whether the sales data of the respective sales commodities has achieved related specific values according to the sales criteria and the corresponding factors (for example, it is determined whether the amount of money is qualified, whether the quantity is qualified, and others), thus to grade the sales commodities, and provide corresponding indication data of the respective sales commodities, wherein each grade corresponds to one indication data.

Then, the processing unit 1120 can use a classification algorithm to set up a machine sales model according to the attributes and the indication data corresponding to the sales commodities, and apply each of the candidate commodities to the machine sales model, thus to obtain the indication data for the corresponding candidate commodity. The classification algorithm may be implemented in various manners. The classification algorithm may be a decision tree, a neural network, a support vector machine, a bayesian classification, a linear discriminant, or a fuzzy classification. The decision tree is used as an example in the following paragraphs, and the present invention is not limited thereto.

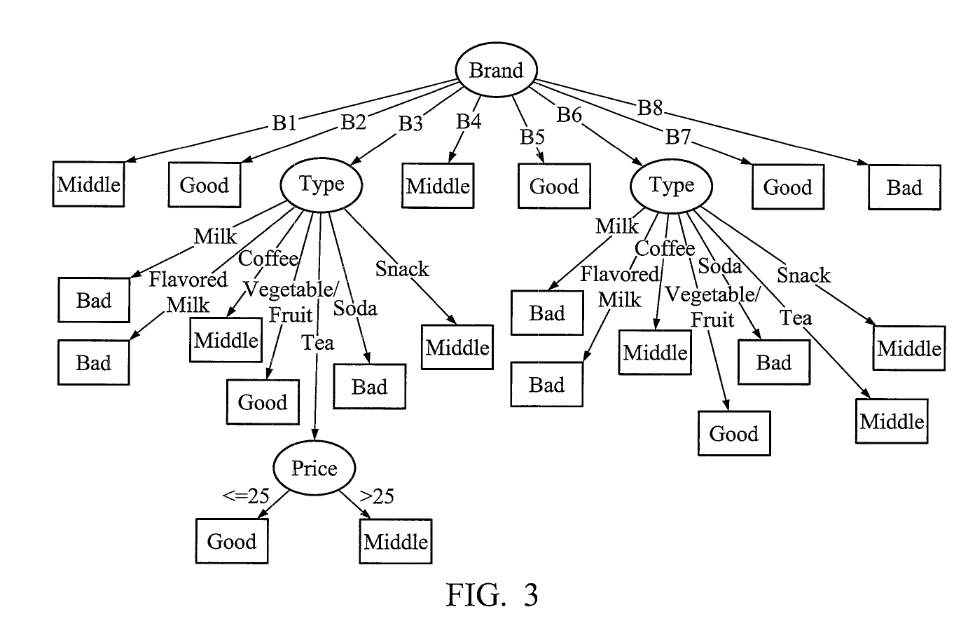

FIG. 3 is a schematic diagram illustrating an example of a machine sales model. The attributes of the sales commodities include the brand, type, and price, and the specific indication data includes “Bad”, “Middle”, and “Good”. In this embodiment, the brand is the classification factor for the first stage of the decision tree, the type is the classification factor for the second stage of the decision tree, and the price is the classification factor for the third stage of the decision tree. Further, in this embodiment, the establishment of the stages is based on the impurity measure of the attributes. The possible functions to measures impurity are entropy, information gain, gain ratio, and gini index. It is understood that, during the establishment of a tree, each stage is classified according to an attribute. When an attribute has a large impurity, the attribute can be used in an upper stage of the tree. When an attribute has a smaller impurity, the attribute can be used in a lower stage of the tree. It is understood that, each attribute may correspond to one of a plurality of different contents. The impurity of the attribute can be determined according to contents of the attribute and the indication data. For example, the impurity of the attribute can be the degree that each commodity subset split by the contents of the attribute belongs to the same specification indication data. In this embodiment, if the degree that each subset divided by the contents of one attribute (like brand) belongs to the same specific indication data is maximum among other attributes (such as type, price), this attribute is chosen as the classification factor in this stage and a further determination for next stage is performed. Then, it is determined whether, for each specific content of the attribute (such as brand), the degree that the commodities of the subset with the specific content belongs to the same specific indication data exceeds the predefined ratio, thus to determine whether to directly correspond each specific content of the attribute to the specific indication data. If the degree that the commodities of the subset with the specific content belongs to the same specific indication data does not exceed the predefined ratio, then another attribute with maximum impurity is chosen as the classification factor. Based on the above principles, the nodes and terminals in the decision tree are created until each of the terminals belongs to one of the specific indication data, thus to generate the machine commodity model.

Then, the processing unit 1120 can apply each of the candidate commodities to the machine sales model, thus to obtain the indication data for the corresponding candidate commodity. For example, the candidate commodities P46˜P61 can be applied to the machine sales model in FIG. 3, thus to obtain the indication data for the corresponding candidate commodity, as shown in Table 2.

TABLE 2

| Product Serial | | | | | | | Indication |
|---|---|---|---|---|---|---|---|
| Number | Product Name | Type | Brand | Packing | Volume | Price | Data |
| P46 | Product P(350 ml) | Vegetable/ | B9 | Plastics | 350 ml | 23 | |
| | | Fruit | | | | | |
| P47 | Product Q(290 ml) | Coffee | B6 | Plastics | 290 ml | 27 | Middle |
| P48 | Product C(400 ml) | Vegetable/ | B6 | Carton | 400 ml | 23 | Good |
| | | Fruit | | | | | |
| P49 | Product R(240 ml) | Coffee | B6 | Plastics | 240 ml | 18 | Middle |
| P50 | Product S(250 ml) | Vegetable/ | B3 | Carton | 250 ml | 9 | Good |
| | | Fruit | | | | | |
| P51 | Product T(250 ml) | Tea | B3 | Carton | 250 ml | 9 | Good |
| P52 | Product U(290 ml) | Milk | B3 | Carton | 290 ml | 26 | Bad |
| P53 | Product V(480 ml) | Tea | B3 | Carton | 480 ml | 15 | Good |
| P54 | Product W(600 ml) | Tea | B3 | Plastics | 600 ml | 18 | Good |
| P55 | Product X(250 ml) | Tea | B8 | Carton | 250 ml | 9 | Bad |
| P56 | Product G(350 ml) | Soda | B5 | Aluminum | 350 ml | 18 | Good |
| P57 | Product Y(100 g) | Snack | B6 | Plastics | 100 ml | 12 | Middle |
| P58 | Product Z | Sport Drink | B10 | Aluminum | 350 ml | 20 | |
| P59 | Product AA(60 g) | Tea | B3 | Carton | 60 ml | 35 | Good |
| P60 | Product AB(355 ml) | Soda | B1 | Aluminum | 355 ml | 18 | Middle |
| P61 | Product AC(200 ml) | Energy Drink | B11 | Glass | 200 ml | 23 | |

In some embodiments, during the determination of indication data for the respective candidate commodity, the processing unit 1120 can further calculate a conditional probability for the respective candidate commodity according to the machine sales model, wherein the conditional probability is a probability that the indication data of the respective candidate commodity becomes a specific indication data, such as “Good” under the attribute of the candidate commodity. The candidate commodities can be sorted according to the respective conditional probabilities, thus to determine a sequence of the candidate commodities to be selected for replacing the sales commodities.

Next, the processing unit 1120 can select at least one of the candidate commodities with first specific indication data to replace at least one of the sales commodities with second specific indication data. In some embodiments, the candidate commodities with indication data “Good” can be selected to replace the sales commodities with indication data “Bad”. When the number of the sales commodities with the second specific indication data is greater than the number of the candidate commodities with the first specific indication data, the processing unit 1120 can further select at least one of the candidate commodities with a third specific indication data to replace a portion of the sales commodities with the second specific indication data. For example, when the number of the sales commodities with indication data “Bad” exceeds the number of the candidate commodities with indication data “Good” by three, three candidate commodities with indication data “Middle” can be selected to replace the three of the sales commodities with indication data “Bad”.

It is noted that, after the candidate commodities are applied to the machine sales model, some candidate commodities may have no indication data, such as product P46, P58 and P61 in Table 2. The processing unit 1120 can further determine a specific number of candidate commodities without indication data to replace a portion of the sales commodities with the second specific indication data, according to the number of the sales commodities with the second specific indication data, the number of the candidate commodities with the first specific indication data, and the number of the candidate commodities without indication data.

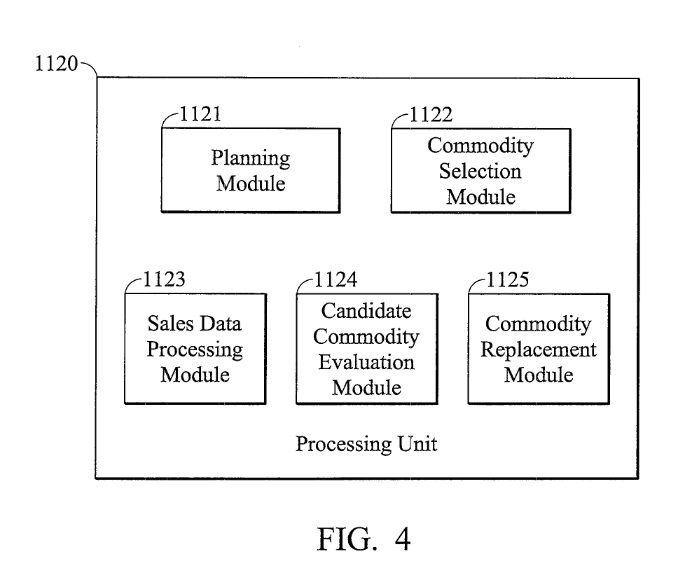

In some embodiments, the main functions of the processing unit 1120 can be performed by various function modules, as shown in FIG. 4. In this embodiments, the processing unit 1120 can executes a planning module 1121, a commodity selection module 1122, a sales data processing module 1123, a candidate commodity evaluation module 1124, and a commodity replacement module 1125, thus to complete the main functions of the processing unit 1120. The sales data processing module 1123 can determine indication data of the respective sales commodity according to the sales data of the respective sales commodities, wherein the indication data is one of a plurality of specific indication data. The sales data processing module 1123 can also use a classification algorithm to set up a machine sales model according to the attributes and the indication data corresponding to the sales commodities. The candidate commodity evaluation module 1124 can apply each of the candidate commodities to the machine sales model, thus to obtain the indication data for the corresponding candidate commodity. The commodity replacement module 1125 can select at least one of the candidate commodities with first specific indication data to replace at least one of the sales commodities with second specific indication data.

Additionally, the processing unit 1120 may have functions for planning the storage areas and planning commodities to be sold for the first time. Since each of the sales commodities is placed in one of the storage areas of the commodity sales machine, and each storage area has a size to hold the commodities in various sizes, the size of a candidate commodity used to replace a specific sales commodity must not be bigger than the size of the storage area. The storage area may be a slot of a vending machine, or an area of a commodity showcase/an open commodity shelf by self-help shopping. For example, the planning module 1121 can divide the slots of the vending machine into a plurality of classes according to the slot sizes of the slots of the vending machine. Further, the classes of the storage area (such as the slot of the vending machine) can be sorted according to the sizes of the classes, such as by height and width. It is noted that, the purpose of classification and sorting of the storage areas is to systematically and efficiently select commodities for the commodity sales machine. In some embodiments, the planning module 1121 and the operation thereof can be omitted.

The commodity selection module 1122 can determine the commodities to be sold in the commodity sales machine 1300 for the first time. The commodity selection module 1122 selects commodities with a size smaller than the size of the respective storage area of the commodity sales machine 1300 from the commodities for sale, as slate candidate commodities. It is noted that, the number of the slate candidate commodities may be greater than, equal to, or less than the number of the storage areas. In some embodiments, the commodity selection can be directly performed for each of the storage areas. In the embodiment of the classified storage areas, the commodity selection module 1122 can select commodities with a size smaller than the size of the respective storage area in a class from all commodities for sale. It is understood that, the class which has a smaller size, and the commodity selection has not been performed thereto, can be first selected among the classes to be perform with the commodity selection. The selected commodities may be the slate candidate commodities. Then, it is determined whether the number of the storage areas in the class is less than the number of the slate candidate commodities. When the number of the storage areas in the class is not less than the number of the slate candidate commodities, the slate candidate commodities can be allotted to the storage areas in the class using a round robin arrangement, such that the sales commodities for the storage areas in the class are determined. When the number of the storage areas in the class is less than the number of the slate candidate commodities, the sales commodities for the storage areas in the class can be determined according to the attributes of the slate candidate commodities by using a meta-heuristic algorithm. It is noted that, the attribute coverage corresponding to the sales commodities determined using the meta-heuristic algorithm is maximum than other combinations of sales commodities. That is, n commodities are selected from p commodities covering m attributes, such that the attribute coverage is maximum. As described, each attribute may correspond to one of a plurality of different contents, and the coverage of the attributes means the number of the corresponded contents. A plurality of combinations of the commodities can be determined, and a specific combination of the sales commodities can be determined as the sales commodities among the determined combinations, wherein the coverage of the attributes corresponding to the specific combination of the commodities is maximum among other combinations of the commodities. After the sales commodities for the storage areas in the class are determined, the commodity selection module 1122 can select another class, and select sales commodities for the selected class, until the commodity selection for all of the classes are completed.

In some embodiments, the meta-heuristic algorithm can be implemented in various manners. For example, the meta-heuristic algorithm may be a genetic algorithm, a simulated annealing, an ant colony algorithm, a hill-climbing algorithm, a tabu search algorithm, and others. When the genetic algorithm is used in this embodiment, the procedure for determining the sales commodities for each class can comprise selection, mating, and mutation operations. Details of the procedures are omitted here. It is understood that, the present invention is not limited to the genetic algorithm, and any meta-heuristic algorithm can be applied in the present invention.

In some embodiments, during the planning of the sales commodities to be sold for the first time, the processing unit 1120 can directly determine the sales commodities for all storage areas of the commodity sales machine 1300 according to the attributes of the commodities using the meta-heuristic algorithm.

Further, as described, the processing unit 1120 can use a classification algorithm to set up a machine sales model according to the attributes and the indication data corresponding to the sales commodities, and applies each of the candidate commodities to the machine sales model, thus to obtain the indication data for the corresponding candidate commodity. Then, the processing unit 1120 can select at least one of the candidate commodities with the first specific indication data to replace at least one of the sales commodities with the second specific indication data.

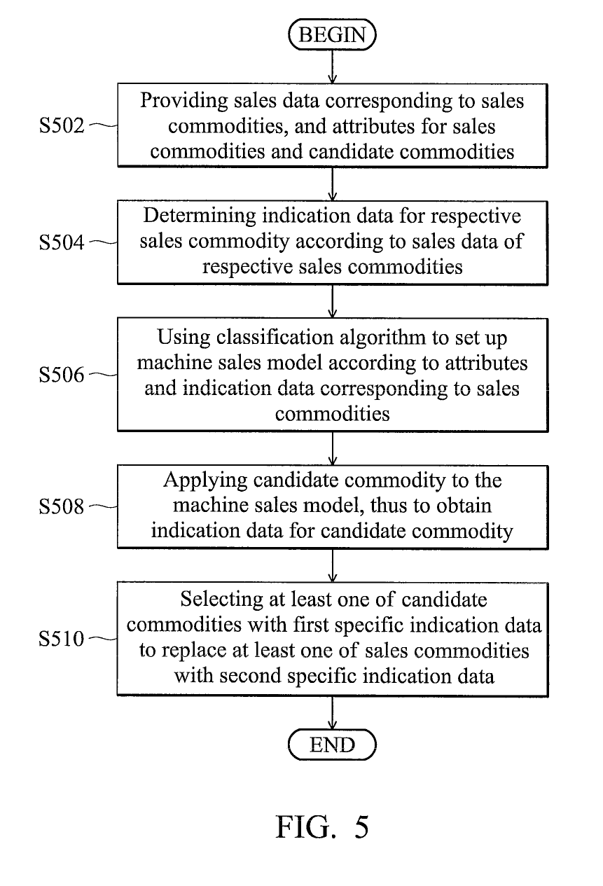

FIG. 5 is a flowchart of an embodiment of a commodity selection method of the invention. The commodity selection method comprises the steps of:

Step S502, a storage unit is provided. The storage unit records sales data corresponding to a plurality of sales commodities of a commodity sales machine, and at least one attribute for each of a plurality of commodities, wherein the commodities include the sales commodities of the commodity sales machine, and a plurality of candidate commodities;

Step S504, indication data for the respective sales commodity is determined according to the sales data of the respective sales commodities, wherein the indication data is one of a plurality of specific indication data;

Step S506, a machine sales model is set up according to the attributes and the indication data corresponding to the sales commodities by using a classification algorithm;

Step S508, each of the candidate commodities is applied to the machine sales model, thus to obtain the indication data for the corresponding candidate commodity; and

Step S510, at least one of the candidate commodities with first specific indication data is selected to replace at least one of the sales commodities with second specific indication data.

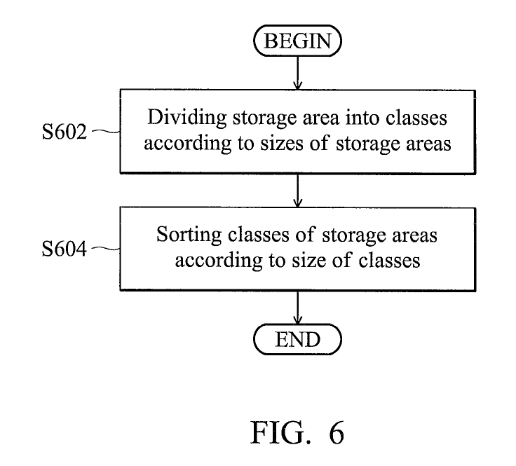

FIG. 6 is a flowchart of an embodiment of a method for planning storage areas of the invention. In step S602, the storage areas of the commodity sales machine 1300 are divided into a plurality of classes according to the sizes of the storage areas of the commodity sales machine 1300. Then, in step S604, the classes of the storage areas are sorted according to the sizes of the classes, such as by height and width. It is noted that, the purpose of classification and sorting of the storage areas is to systematically and efficiently select commodities for the commodity sales machine 1300. In some embodiments, the planning for the storage areas and the operation thereof can be omitted.

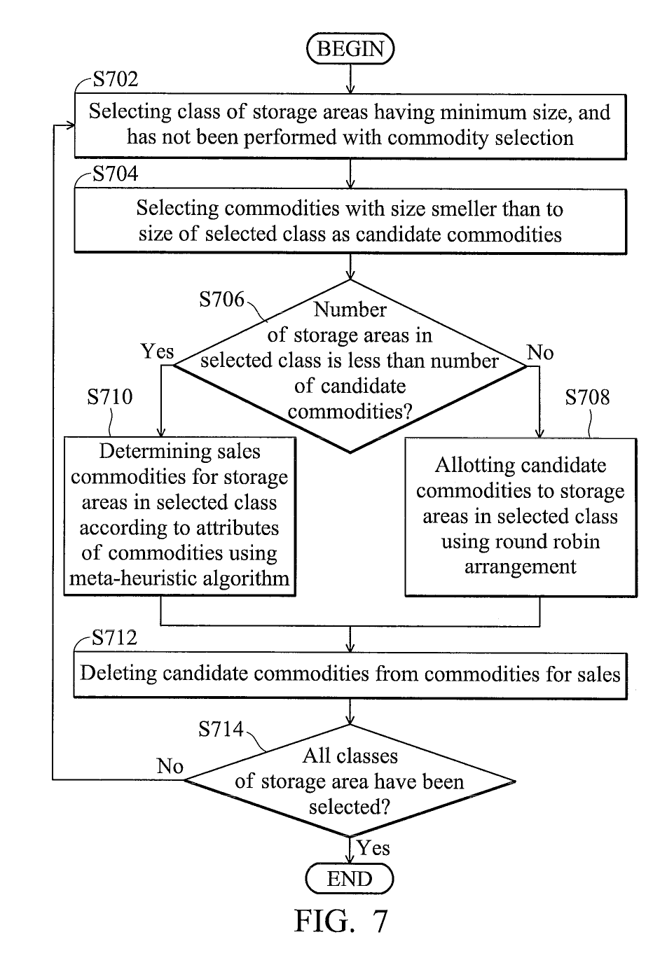

FIG. 7 is a flowchart of an embodiment of a method for selecting commodities to be sold in the commodity sales machine 1300 for the first time of the invention. In step S702, a class of the storage areas having a minimum size is selected from the classes, wherein the commodity selection has not been performed to the classes to be selected. In step S704, commodities with a size smaller than the size of the selected class are selected from the commodities for sale, as slate candidate commodities. In step S706, it is determined whether the number of the storage areas in the class is less than the number of the slate candidate commodities. When the number of the storage areas in the selected class is not less than the number of the slate candidate commodities (No in S706), in step S708, the candidate commodities are allotted to the storage areas in the class using a round robin arrangement, such that the sales commodities for the storage areas in the class are determined. When the number of the storage areas in the class is less than the number of the slate candidate commodities (Yes in step S706), in step S710, the sales commodities for the storage areas in the class are determined according to the attributes of the commodities using a meta-heuristic algorithm.

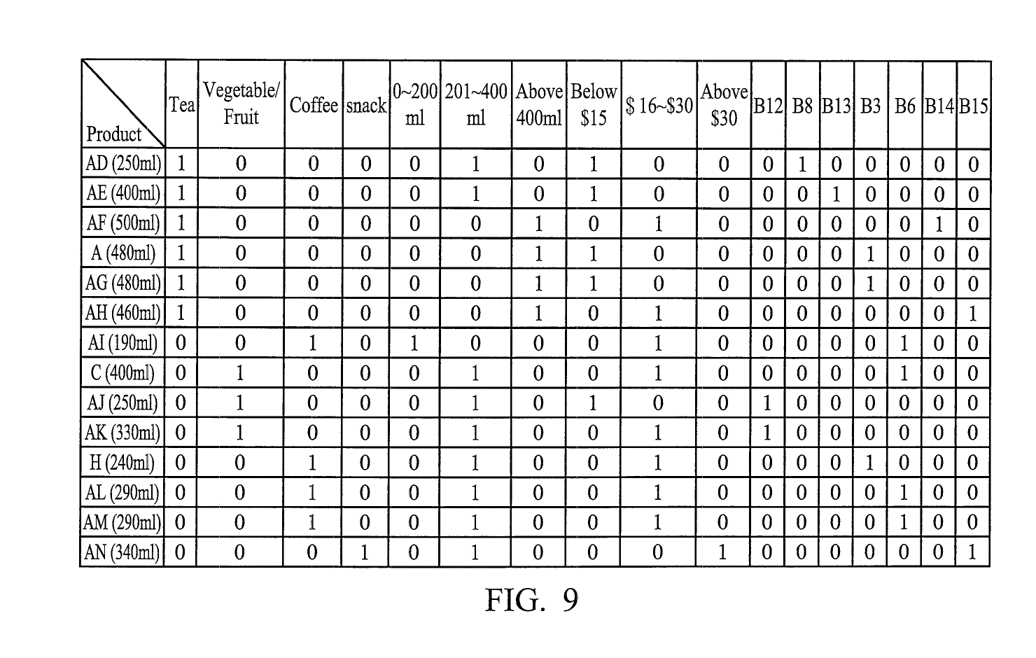

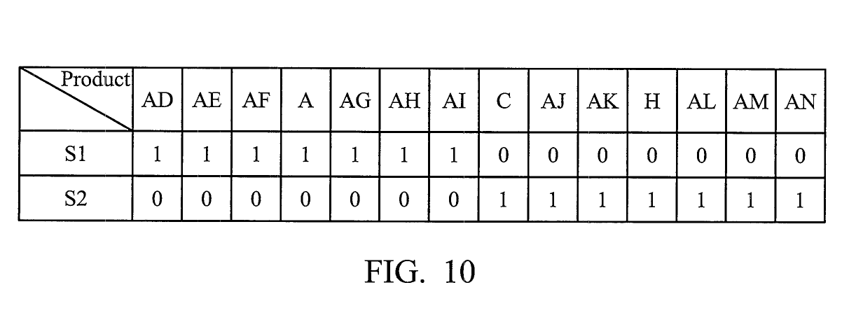

For example, FIG. 9 is a table showing an example of 14 candidate commodities with a size smaller than the size of a class of storage areas having 7 slots. In FIG. 9, the attributes comprises the brand, type, volume, and price of the commodity, and “1” represents that the commodity has the attribute, and “0” represents that the commodity does not have the attribute. It is assumed that S1 and S2 are two combinations for the selected commodities, as shown in FIG. 10. In FIG. 10, “1” represents that the commodity is selected, and “0” represents that the commodity is not selected. The attribute coverage of S1 includes 13 attributes (“tea”, “coffee”, “0˜200 ml”, “201˜400 ml”, “above 400 ml”, “below $15”, “$16˜$30”, “B8”, “B13”, “B3”, “B6”, “B14”, and “B15”), and the attribute coverage of S2 includes 11 attributes (“vegetable/fruit”, “coffee”, “snack”, “201˜400 ml”, “below $15”, “$16˜$30”, “above $30”, “B12”, “B3”, “B6”, and “B15”). Since the attribute coverage of S1 is greater than that of S2 (13>11), the commodity combination of S1 can be selected as the sales commodities for the class of storage areas.

Referring to FIG. 7 again, after the sales commodities for the class of storage areas is determined, in step S712, the selected slate candidate commodities are deleted from the commodities for sale, thus preventing the selected slate candidate commodities to be repeatedly selected. Then, in step S714, it is determined whether all of the classes of storage areas have been selected. If so (Yes in step S714), the procedure is completed. If not (No in step S714), the procedure returns to step S702 to select another class for subsequent operations.

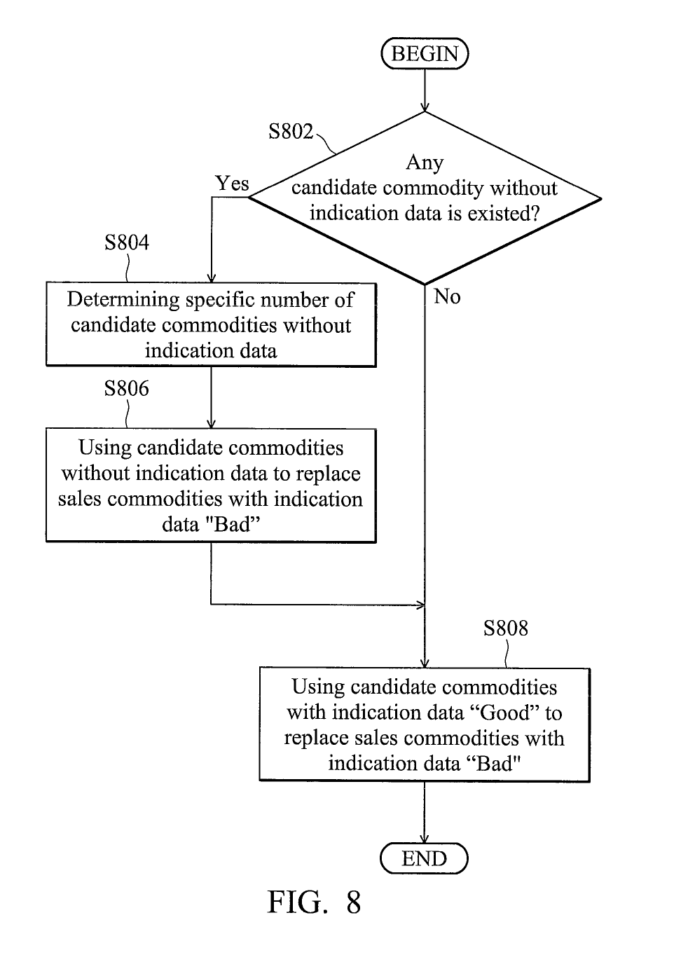

FIG. 8 is a flowchart of an embodiment of a method for a commodity replacement of the invention. In step S802, it is determined whether a candidate commodity without indication data exist. If no (No in step S802), the procedure goes to step S808. If at least one candidate commodity without indication data exist (Yes in step S802), in step S804, a specific number of candidate commodities without indication data is determined according to the number of the sales commodities with indication data “Bad”, the number of the candidate commodities with indication data “Good”, and the number of the candidate commodities without indication data, and in step S806. The candidate commodities without indication data determined in step S804 is used to replace the sales commodities with indication data, such as “Bad”. Then, in step S808, the candidate commodities with indication data “Good” is used to replace the sales commodities with indication data “Bad”.

It is understood that, in the embodiment of FIG. 8, a portion of the candidate commodities without indication data can be used to replace the sales commodities. However, in some embodiments, only the candidate commodities with indication data can be used to replace the sales commodities.

Therefore, the commodity selection systems and methods can generate a machine sales model for a commodity sales machine according to the sales data of the commodity sales machine, thus to dynamically adjust the sales commodities on the commodity sales machine. Further, several commodity sales machines, such as machines in an unmanned store, or machines belonging to a region can be integrated to generate a corresponding machine sales model, thus to efficiently select appropriate sales commodities.

Commodity selection systems and methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

In some embodiments, the program codes implementing the commodity selection method may comprise a first program code for obtaining sales data corresponding to a plurality of sales commodities of at least one commodity sales machine, a second program code for obtaining at least one attribute for each of the sales commodities, and at least one attribute for each of a plurality of candidate commodities, a third program code for determining indication data of the respective sales commodity according to the sales data of the respective sales commodities, wherein the indication data is one of a plurality of specific indication data, a fourth program code for setting up a machine sales model according to the attributes and the indication data corresponding to the sales commodities using a classification algorithm, and applying each of the candidate commodities to the machine sales model, thus to obtain the indication data for the corresponding candidate commodity, and a fifth program code for selecting at least one of the candidate commodities with first specific indication data to replace at least one of the sales commodities with second specific indication data.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A commodity selection system, comprising:
a storage unit recording sales data corresponding to a plurality of sales commodities of a commodity sales machine, and at least one attribute for each of a plurality of commodities, wherein the commodities include the sales commodities of the commodity sales machine, and a plurality of candidate commodities; and
a processing unit determining indication data of the respective sales commodity according to the sales data of the respective sales commodities, wherein the indication data is one of a plurality of specific indication data, setting up a machine sales model according to the attributes and the indication data corresponding to the sales commodities by using a classification algorithm, applying each of the candidate commodities to the machine sales model, thus to obtain the indication data for the corresponding candidate commodity, and selecting at least one of the candidate commodities with first specific indication data to replace at least one of the sales commodities with second specific indication data.

2. The system of claim 1, wherein the processing unit further clusters the sales commodities according to the sales data of the respective sales commodities by using a clustering algorithm, thus to obtain a plurality of clusters, wherein the sales commodities in each cluster have the same indication data.

3. The system of claim 2, wherein the processing unit further calculates a sales achievement for the respective sales commodity according to the sales data of the respective sales commodity using a specific formula, and provides the sales achievement to the clustering algorithm for clustering.

4. The system of claim 2, wherein when each of the candidate commodities is applied to the machine sales model, and at least one of the candidate commodities without indication data is existed, the processing unit further determines a specific number of the candidate commodities without indication data to replace a portion of the sales commodities in a specific cluster according to the number of the sales commodities in the specific cluster, the number of the candidate commodities with the first specific indication data, and the number of the candidate commodities without indication data.

5. The system of claim 1, wherein during the replacement of the sales commodities with the second specific indication data, when the number of the sales commodities with the second specific indication data is greater than the number of the candidate commodities with the first specific indication data, the processing unit further selects at least one of the candidate commodities with third specific indication data to replace a portion of the sales commodities with the second specific indication data.

6. The system of claim 1, wherein the processing unit further calculates a conditional probability for the respective candidate commodity according to the machine sales model, wherein the conditional probability is a probability that the indication data of the respective candidate commodity becomes the first specific indication data under the attribute of the candidate commodity.

7. The system of claim 6, wherein the processing unit further determines a sequence of the candidate commodities according to the conditional probabilities of the respective candidate commodities, wherein the sequence of the candidate commodities is selected to replace the sales commodities with the second specific indication data.

8. The system of claim 1, wherein each of the sales commodities is placed at one of a plurality of storage areas of the commodity sales machine, wherein each of the storage area has a size, and the size of the candidate commodity used to replace a specific sales commodity is smaller than the sizes of the storage area placing the specific sales commodity, and the processing unit further classifies the storage areas into a plurality of classes of storage areas according to the sizes of the storage areas of the commodity sales machine, and sorts the classes of storage areas.

9. The system of claim 8, wherein during selection of sales commodities to be sold in the commodity sales machine for the first time, the processing unit further selects commodities with a size smaller than the size of the storage areas in a class as slate candidate commodities, wherein the class of the storage areas has a minimum size, and the commodity selection has not been performed to the class.

10. The system of claim 9, wherein the processing unit further determines whether the number of the storage areas in the selected class is less than the number of the slate candidate commodities, and when the number of the storage areas in the selected class is not less than the number of the slate candidate commodities, the slate candidate commodities are allotted to the storage areas in the selected class by using a round robin arrangement, and when the number of the storage areas in the selected class is less than the number of the slate candidate commodities, the sales commodities for the storage areas in the selected class are determined according to the attributes of the slate candidate commodities by using a meta-heuristic algorithm.

11. The system of claim 1, wherein the processing unit further determines the sales commodities to be sold in the commodity sales machine for the first time according to the attributes of commodities by using a meta-heuristic algorithm, wherein an attribute coverage corresponding to the determined sales commodities is maximum.

12. The system of claim 1, wherein the processing unit further sets up a specific machine sales model for a plurality of specific commodity sales machines according to the attributes and the indication data corresponding to the sales commodities corresponding to the specific commodity sales machines by using the classification algorithm, applies each of the candidate commodities to the specific machine sales model, thus to obtain the indication data for the corresponding candidate commodity, and selects at least one of the candidate commodities with the first specific indication data to replace at least one of the sales commodities with the second specific indication data.

13. A commodity selection method, comprising:
providing a storage unit, wherein the storage unit records sales data corresponding to a plurality of sales commodities of a commodity sales machine, and at least one attribute for each of a plurality of commodities, wherein the commodities include the sales commodities of the commodity sales machine, and a plurality of candidate commodities;
determining indication data for the respective sales commodity according to the sales data of the respective sales commodities, wherein the indication data is one of a plurality of specific indication data;
setting up a machine sales model according to the attributes and the indication data corresponding to the sales commodities by using a classification algorithm, and applying each of the candidate commodities to the machine sales model, thus to obtain the indication data for the corresponding candidate commodity; and
selecting at least one of the candidate commodities with first specific indication data to replace at least one of the sales commodities with second specific indication data.

14. The method of claim 13, further comprising a step of clustering the sales commodities according to the sales data of the respective sales commodities by using a clustering algorithm, thus to obtain a plurality of clusters, wherein the sales commodities in each cluster have the same indication data.

15. The method of claim 14, further comprising steps of:
calculating a sales achievement for the respective sales commodity according to the sales data of the respective sales commodity using a specific formula; and
providing the sales achievement to the clustering algorithm for clustering.

16. The method of claim 14, wherein when each of the candidate commodities is applied to the machine sales model, and at least one of the candidate commodities without indication data is existed, the method further comprises a step of determining a specific number of the candidate commodities without indication data to replace a portion of the sales commodities in a specific cluster according to the number of the sales commodities in the specific cluster, the number of the candidate commodities with the first specific indication data, and the number of the candidate commodities without indication data.

17. The method of claim 13, wherein during the replacement of the sales commodities with the second specific indication data, when the number of the sales commodities with the second specific indication data is greater than the number of the candidate commodities with the first specific indication data, the method further comprises a step of selecting at least one of the candidate commodities with third specific indication data to replace a portion of the sales commodities with the second specific indication data.

18. The method of claim 13, further comprising a step of calculating a conditional probability for the respective candidate commodity according to the machine sales model, wherein the conditional probability is a probability that the indication data of the respective candidate commodity becomes the first specific indication data under the attribute of the candidate commodity.

19. The method of claim 18, further comprising a step of determining a sequence of the candidate commodities according to the conditional probabilities of the respective candidate commodities, wherein the sequence of the candidate commodities is selected to replace the sales commodities with the second specific indication data.

20. The method of claim 13, wherein each of the sales commodities is placed at one of a plurality of storage areas of the commodity sales machine, and each of the storage area has a size, and the sizes of the candidate commodity used to replace a specific sales commodity is smaller than the size of the storage area placing the specific sales commodity, and the method further comprises steps of classifying the storage areas into a plurality of classes of storage areas according to the sizes of the storage areas of the commodity sales machine, and sorting the classes of storage areas.

21. The method of claim 13, further comprising a step of determining the sales commodities to be sold in the commodity sales machine for the first time according to the attributes of commodities by using a meta-heuristic algorithm, wherein an attribute coverage corresponding to the sales commodities is maximum.

22. The method of claim 13, further comprising:
setting up a specific machine sales model for a plurality of specific commodity sales machines according to the attributes and the indication data corresponding to the sales commodities corresponding to the specific commodity sales machines by using the classification algorithm, and applying each of the candidate commodities to the specific machine sales model, thus to obtain the indication data for the corresponding candidate commodity; and
selecting at least one of the candidate commodities with the first specific indication data to replace at least one of the sales commodities with the second specific indication data.

23. A machine-readable storage medium comprising a computer program, which, when executed, causes a device to perform a commodity selection method, and the method comprises:
obtaining sales data corresponding to a plurality of sales commodities of a commodity sales machine;
obtaining at least one attribute for each of a plurality of commodities, wherein the commodities include the sales commodities of the commodity sales machine, and a plurality of candidate commodities;
determining indication data for the respective sales commodity according to the sales data of the respective sales commodities, wherein the indication data is one of a plurality of specific indication data;
setting up a machine sales model according to the attributes and the indication data corresponding to the sales commodities by using a classification algorithm to, and applying each of the candidate commodities to the machine sales model, thus to obtain the indication data for the corresponding candidate commodity; and
selecting at least one of the candidate commodities with first specific indication data to replace at least one of the sales commodities with second specific indication data.
